(19) United States
(12) Patent Application Publication
(10) Pub. No.: US 2014/0129914 A1
(43) Pub. Date: May 8, 2014

(54) METHOD OF PRE-POPULATING EDITABLE ELECTRONIC FORMS USING TRUSTED RELATIONSHIP BASED ID CODES

(71) Applicant: Rahul Agarwal, Fremont, CA (US)

(72) Inventor: Rahul Agarwal, Fremont, CA (US)

(21) Appl. No.: 13/672,536

(22) Filed: Nov. 8, 2012

(51) Int. Cl. G06F 17/24

(52) U.S. Cl. CPC G06F 17/243
USPC 715/226

(57) ABSTRACT

A computer based system and method to automatically pre-populate many different types of editable electronic forms from many different organizations with previously entered user data. This previously entered user data is generally obtained by parsing data from previously submitted forms, and cumulatively storing this data in a database designed to allow data sharing between different organizations and forms. Thus the method grows in competence with increasing use. At least some of the users will be primary users (e.g. parents) who are in a position of trust with respect to secondary users (i.e. their children or other charges). In a preferred embodiment, the invention's identification numbers (assigned to various users) will also be used to identify the trust relationship between primary users and their corresponding secondary users.

### BACKGROUND OF THE INVENTION

1. Field of the Invention

This invention is in the field of electronic forms management, and more specifically in the field of computer systems and methods in which a computer server can electronically manage and exchange personal information between a plurality of organizations and a plurality of forms.

2. Description of the Related Art

As any individual who has a trusted relationship for the care of another individual (such as the parents of children, or children charged with the care of elderly parents) can attest, often a considerable amount of time and energy is spent filling out various forms from various organizations. These forms can include application forms, registration forms, order forms, medical forms, immigration forms, job forms, travel forms, and the like. Thus in addition to the burden of having to fill out his or her own forms, an individual in a position of trust and responsibility for other individuals also has to fill out many other forms for their various charges, such as their children, parents, or other individuals as well.

In earlier years, such forms were usually paper forms, to be filled out by handwriting or typing and then physically submitted. However as computer technology and network communications have advanced, use of electronic forms, often filled out electronically on a computerized client device, often using a web browser, app, or PDF program has become common. These electronic forms are then often submitted electronically from various client devices to servers over the internet.

In the electronic forms area, as one example, Adobe Systems, Incorporated, San Jose Calif., and others have worked to produce the Portable Document Format (ISO 32000) electronic forms format. This format allows the creation of electronic forms that retain much of the look and feel of paper based forms, while at the same time allowing the data that is entered into the various form fields to be easily captured and parsed by various computer systems. As a result, for example, the user entered data from the electronic PDF forms may then be stored in various computer databases for subsequent processing.

Web based electronic forms, often based on various versions of HTML (e.g. HTML5) and associated languages such as JavaScript, Java and the like are also common.

As a result, it is now common, for example, to fill out and submit electronic versions of many forms. Such forms can include forms intended to be transmitted from one or more individuals to a single organization, such as electronic income tax forms. Indeed income tax programs, such as the popular income tax programs produced by Intuit or HR Block, also can take income tax data from an individual or family, and in turn produce filled out State and Federal Income tax forms, and electronically submit these forms to both State and Federal governments.

Similarly parents of college age children may find that both they and their children can facilitate the college admissions process by using a centralized college application form submitting service called the “Common Application”. Under the Common Application, various colleges and universities agree to use a standardized application form. This system allows a student, with optional parental assistance, to use a standard web browser, communicate with the Common Application's servers, fill out a single master college application, and then send the data from this single master application to up to hundreds of different colleges.

On a different topic, as computer use has proliferated, there has also been prior art focused on solving the problem of providing identification methods capable of securely identifying individuals to computer systems.

These ID systems include proprietary systems, such as Microsoft Passport, and open systems such as OpenID. Microsoft Passport, also known as Windows Life ID and Microsoft account allows users to sign on to various websites using a single account, often based on the user's email address. OpenID, which is an open standard produced by the OpenID Foundation, provides for a decentralized method of identifying users to various computer systems.

Despite these advances, however, the everyday problem that individuals and families face of constantly filling out large numbers of different types of forms from different organizations, often with the same types of repetitive information, persists. Thus further advances in these fields would be desirable.

### BRIEF SUMMARY OF THE INVENTION

The invention is based, in part, on the insight that what is needed is an improved system and method of electronic data sharing that would allow, for example, information submitted by a user to a first organization to be recycled (where appropriate) and then used to help assist the user submit information to a second organization. Similarly the information submitted by the user to a second organization could be recycled, along with the information from the first organization, to give even more assistance to the user submitting information to a third organization, and so on.

However because, in contrast to college admission forms or income tax forms, where different organizations often ask for the same data, in the real world, different organizations often ask for different types of data. Thus, in contrast to prior art, according to the invention, the system should be able to gradually accumulate data, share knowledge across different forms, and gracefully cope with missing data or inconsistent data.

The invention is also based, in part, on the insight that when parents and other primary users fill out forms for their children or other secondary users that the primary user is responsible for, often the forms for the secondary users (e.g. children) require both information on the parent (primary user), and often also require much repetitive and overlapping information on the secondary users (e.g. children) as well. Thus methods that would further allow a responsible primary user, such as a parent, to easily indicate to a computer system which secondary users the primary user is also acting for, then the information recycling aspects of the invention would be even further enhanced.

The invention is also based, in part, on the insight that to achieve these ends, what is needed is a new type of computer based system and method that can take as input, many different types of forms from many different types of organizations, and assign standardized database fields to the respective organizational form fields. Thus for example, the invention would first work to determine all the different ways that a user's name, birth date, address, telephone number and the like are captured by the large number of different forms, and devise a parsing or mapping scheme by which a user address can be captured from an address field on a first form, and then reused in turn to fill out an address field on a second form.

With regards to using this new type of computer based system and method to allow primary users (e.g. parents) to also fill out information for their secondary users (e.g. relatives such as children or grandparents), the operation of this new type of computer based system will be further facilitated if a primary user's ID code also contains, or can be linked to, information that identifies the respective secondary users as well. That is the invention's ID code should also ideally be used in a manner that also identifies the trust relationship between various primary users and various secondary users.

Thus, in some embodiments, the invention may be a computer based system and method to automatically pre-populate editable electronic forms with previously entered user data. In some embodiments, the invention may operate by assigning identification numbers to various users. Generally at least some of the users will be primary users (e.g. parents) who are in a position of trust with respect to secondary users (i.e. their children or other charges). In a preferred embodiment, the invention's identification numbers (assigned to various users) will also be used to identify the trust relationship between a given primary user and his or her corresponding secondary users.

As previously discussed, the invention will generally use multiple user editable electronic forms (e.g. web forms, app forms, PDF forms, and the like) obtained from a number of different organizations, and it will collect the data that the primary user enters for himself, herself, and/or for their respective secondary users, and store this information in a database. The invention will also extract this user entered information and parse or sort this information according to the information's or electronic form's data type or field.

The advantages of this approach is when a primary user then desires to fill out a new form (or have old forms automatically updated with updated information), the system can use the invention's identification number, and data from the database, to automatically pre-populate at least some of the fields in the new form with data from the database, and send this “automatically filled out” form to the user to then verify and/or additionally edit as needed. The net result is to greatly reduce the time and effort in filling out forms, as well as to likely improve the accuracy of the data in the forms as well.

### BRIEF DESCRIPTION OF THE DRAWINGS

FIG. 1 shows an example of how using prior art, a parent might fill out various forms for his two children, shown here enrolling with three different organizations.

FIG. 2 shows an example of how the same parent might use the invention to reduce the time and effort needed fill out various forms for the same two children, here enrolling with the same three organizations.

FIG. 3 shows an example of the invention operating for the first time, using an editable electronic form for organization 1. Since this is the first time, the invention provides an essentially blank (i.e. not-pre-populated form) to the parent, who fills it out and transmits it back to the server. The server parses the form, extracts and stores the child's personal data in a database for possible later reuse, and also sends the form back to the first organization (not shown).

FIG. 4 shows an example of the invention operating at a later time, here using an editable electronic form for organization 2. Since this is the later time, the invention uses personal data on the child (secondary user) to pre-populate as much of organization 2's editable electronic form as it can given available data, and then sends the partially pre-populated form to the parent (primary user).

FIG. 5 shows an example of the invention operating at an even later time, here using an editable electronic form for organization 3. Since this an even later time, the invention now has quite a large amount of personal data on the child (secondary user) available, and can pre-populate almost all of organization 3's editable electronic form.

FIG. 6 shows an example of how the invention's server and database operates to partially pre-populate the organization 2 electronic form from FIG. 4.

FIG. 7 shows an example of how the invention also parses data from various electronic forms from different organization, and uses this data to further populate its database with additional personal data for use in filling out subsequent forms.

### DETAILED DESCRIPTION OF THE INVENTION

To better understand the fundamentals of the invention, consider a small family, here consisting of a father (100), a daughter (102) and a son (104) all in a trusted relationship (106). Here also assume that the two children are school age children engaged in various activities with various organizations (110, 112, 114), each generating its own set of forms (120, 122, 124) to fill out.

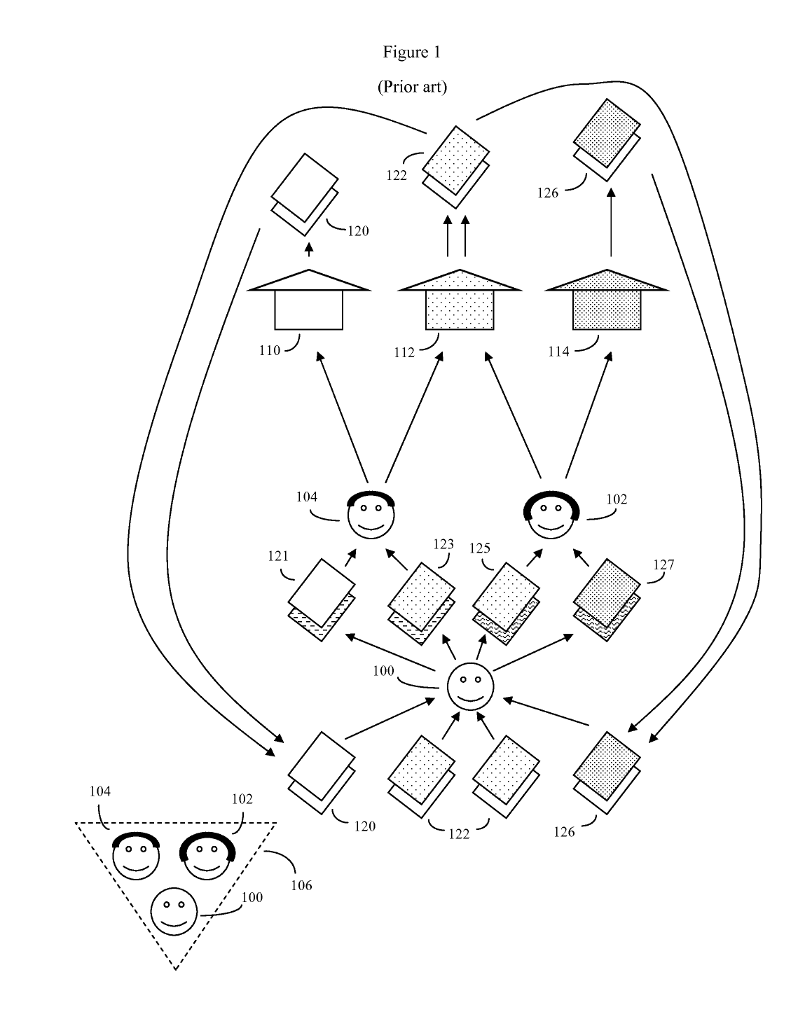

FIG. 1 shows an example of how using prior art, this parent (100) might fill out these various forms (120, 122, 124) for his two children (102, 104). As each organization (110, 112, 114) provides its own set of blank forms (120, 122, 126) to the parent (100), the parent laboriously fills each form out, and then either directly (or indirectly through his children) sends the now filled out forms (121, 123, 125, 127) back to the different organizations. The process is both inefficient and laborious.

According to the invention, however, this inefficient and laborious process may be replaced by an improved automated system and method. Here, the invention, for example, provides a computer system and method to automatically pre-populate the editable electronic forms (e.g. forms 120, 122, 126) with previously entered user data, thus reducing the amount of repetitious data entry, and often also reducing the chances of error as well.

According to the invention, in a preferred embodiment, identification numbers (200) will be assigned to various users. At least some of these users will be primary users (e.g. persons in a position of trust over others, such as parents over young children, or adult children over elderly parents). Here these “others”, the charges who may need help and assistance in filling out forms, will be referred to as “secondary users”.

More specifically, primary users are generally users who are in a position of trust with respect to secondary users. This often includes parents and children, children and parents, spouses, and other individuals with a legal trust relationship.

Again in a preferred embodiment, the identification numbers (200) will, either directly (e.g. as part of a field used to construct the identification number) or indirectly (e.g. through a look-up table) identify the trust relationship between a given primary user or users and the one or more secondary users who need help with their forms. In a married couple with three children, there may be for example be two primary users may also be mutual secondary users (i.e. the husband may delegate to the wife, and the wife may delegate to the husband), and three different secondary users (their three children).

In some embodiments, the identification numbers (200) will, either directly or indirectly, also be formed from or at least be linked to information pertaining additional information, such as the primary user's country of origin, residence, or citizenship, the primary user's original date of registration, a random number, and as previously discussed, information uniquely liking the primary user to one or more secondary users or other primary users (such as a spouse). In some embodiments, the identification numbers may also be based, at least in part, on standard identification numbers such as social security numbers, driver's licenses, and the like.

The invention will use a plurality of user editable electronic forms (e.g. 120, 122, 126) from a plurality of different organizations (110, 112, 114) to collect primary user (100) entered personal data regarding either the one or more primary users and/or their respective one or more secondary users. Usually, a server, such as an internet server (202) and computer database (204) in data communication with the server will first collect the blank (e.g. no user data entered) forms (120, 122, 126) from the various organizations (110, 112, 114), often over a computer network such as the Internet (206).

Essentially any type of organization and any type of form may be covered by the invention. This includes organizations and forms such as after-school/day-care organizations, fitness center/sports-clubs/membership-clubs, educational services/vocational training services, discount card services (e.g. cards issued by Target, Smart and Final, Costco etc.), health care, feedback/survey, events registration, legal, real estate, career services, nanny services, immigration/travel, school, and so on.

The invention's internet server (202) will usually comprise at least one computer processor, as well as computer memory (e.g. RAM, FLASH, ROM, disk drive, and the like), one or more network connections, operating system software (e.g. Linux, Unix, Windows, and the like), database software, and often also web server software (e.g. Apache) and the like. Suitable software stacks (software bundles) used in the server can be LAMP software such as Linux, Apache, MySql, PHP, Perl, Python, and the like.

In some embodiments, the invention's editable electronic forms may be web based electronic forms, and these web based electronic forms may be viewed and edited using a web browser or app in an internet network connected computerized device (client device). Alternatively other electronic form formats, such as the standard Portable Document Format (PDF) forms format, or other standard forms may be used. Often these forms may be designed to visually resemble the organization's standard forms, such as standard paper forms.

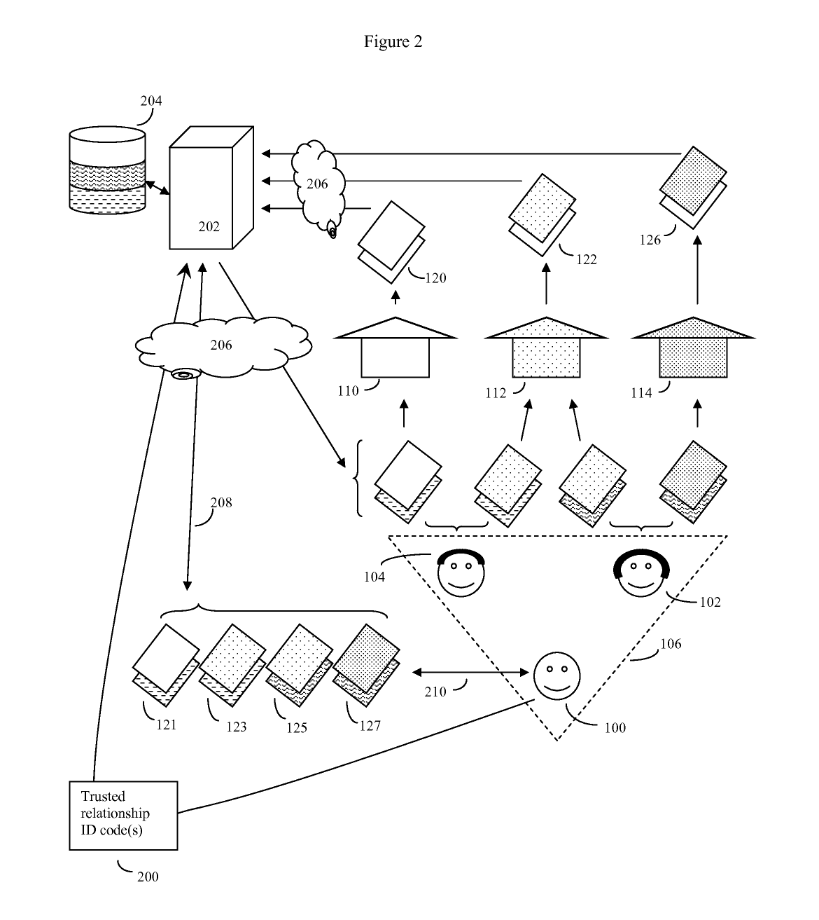

The computerized client device usually used by the user to fill in the various electronic forms will itself generally consist of at least one computer processor, memory, operating system software, network interface and often various Graphical User Interface (GUI) display monitors and user I/O systems. Typical computerized client devices include Smartphones, tablet computers, laptop computers, desktop computers, and the like. In FIG. 2, these are not shown directly, but it should be assumed that at least primary user (100) is using such a client device to communicate with server (202) and optionally with organizations (110, 112, 114).

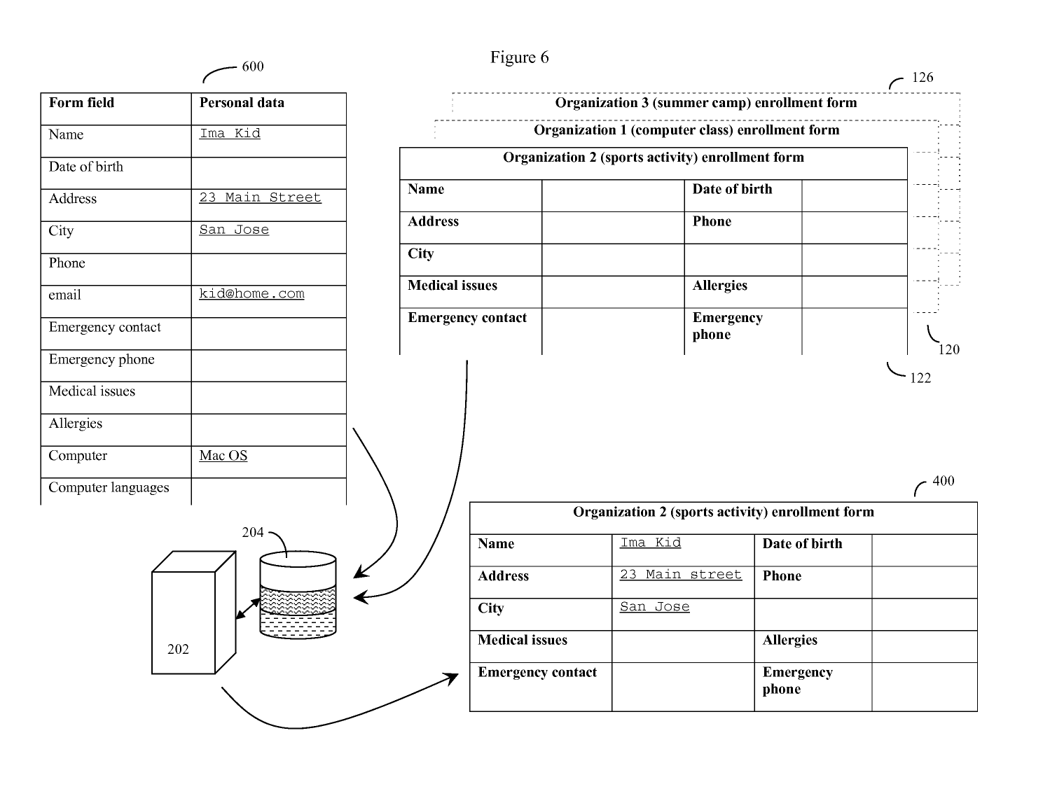

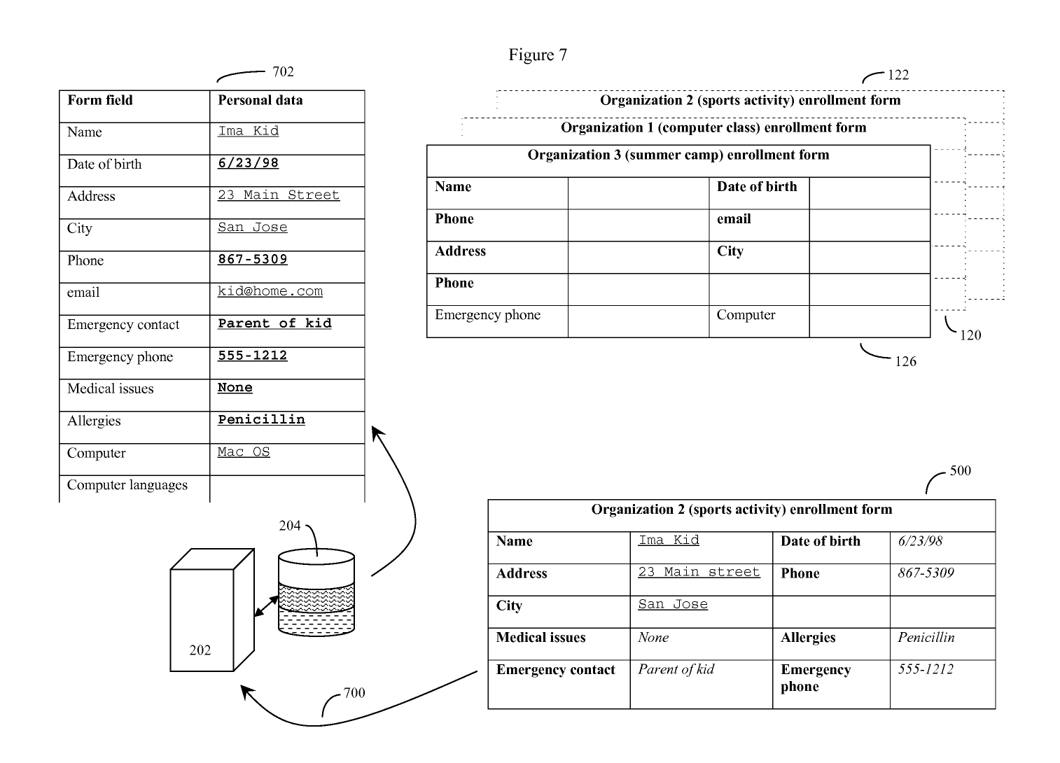

According to the invention, using the blank electronic forms, the data content intended to be represented by the various form fields on the various forms may be interpreted according to a common identification scheme. This common identification scheme is essentially a mapping scheme that allows, for example, a data item such as date of birth, which might be in one location on one electronic form, and on a completely different location on a different electronic form, to always be understood by the system consistently. Thus for example, the system server (202) will have the form field correspondence data or mapping data stored in its memory (e.g. its database memory 204) so that the personal data can always be consistently identified regardless of what form is being used (for more detail, please see FIG. 6 and FIG. 7).

To do this, the invention will generally store the primary user entered personal data and identification numbers in at least one computer database (204), and further sort the primary user entered personal data according to data type, again often according to a mapping scheme that may have a unique mapping correspondence for each different form.

Assume now that the one or more primary users (100) wishes to fill out one or more of the non-filled out (blank) forms (120, 122, 126), or alternatively to review and edit previously filled out (or at least partially pre-populated) versions of these forms, (121, 123, 125, 127). Here the invention (often enabled by use of the identification number (200)) can use the sorted primary user entered personal data from database (204) to pre-populate at least some of the fields in the editable electronic forms (120, 122, 126) with the sorted primary user entered personal data. (See FIG. 6 for a specific example of this process).

The invention can then present (208) these at least partially pre-populated editable electronic forms (121, 123, 125, 127) to the primary users (100) for subsequent primary user editing and/or verification (210). Usually after primary user approval, the invention will then deliver the completed (e.g. filed out) forms to the various organizations (110, 112, 114), either directly by electronic means, or indirectly via the primary and/or secondary users.

Here any and all delivery methods may be used. The primary and/or secondary users may simply direct the server (202) to provide the relevant organization with a link to the filled out forms, or email the filled out forms, or print out and deliver a hard copy of the filled out forms.

Alternatively the primary and/or secondary users may do this themselves. Other methods (e.g. various short range secure wireless methods such as RFID, NFC, to be discussed) may also be used.

The organizations (110, 112, 114) can be essentially any mix of any and all types of organizations. These organizations can include business organizations, educational organizations, government departments, private clubs, and the like.

A diagram showing the invention in operation is shown in FIG. 2. In FIG. 2, the same parent (100) is now using the invention to reduce the time and effort needed fill out various forms for the same two children (102, 104), here enrolling with the same three organizations (110,112, 114).

According to the invention, however, the various organizations first provide blank samples (e.g. with the form's various data fields not filled in) of their respective forms (120, 122, 126) to the invention's server (202) or organization that runs server (202). This forms data is then analyzed, either automatically or semi-manually to determine the data type or content in each form field (for database data storage purposes), and if needed (i.e. if this is not already supplied) will also creates an electronic version of that form. A mapping scheme to map the various form fields in any given form to a standardized database list (600, 702) may also be constructed.

Here, as previously discussed, parent (primary user 100) fills out the forms (120, 122, 126). The parent assists the server (202) in knowing which data and forms to use by giving the server (directly, or indirectly such as through one of the organizations) an ID number (200) that can be used to determine his trusted relationship with his children (102, 104).

Upon direct request to server (202), or upon indirect request (i.e. relayed through organization 110, 112, or 114, for example by using a click through link), the server (202) directly or indirectly provides (208) the primary or secondary users with access to various pre-populated versions (121, 123, 125, 127) of these electronically editable forms. The parent can then view and verify these pre-populated forms (210) and or edit them further as needed.

Although initially, relatively little personal data may be stored in the database (204) (see also list 600), as the primary and secondary users user the invention more and more, an increasing amount of personal data accumulates in database (204) (see list 702). This in turn allows the server (202) to pre-populate each subsequent electronic form with a greater amount of personal data. This reduces the need for the parent to fill out each form from scratch, as well as improving efficiency, and reducing labor needed.

The completed forms (with parent checked pre-populated data, and any new parent added personal data as needed) may then be sent back directly or indirectly to the various organizations, optionally using the children (102 and 104) and/or, as desired, by various electronic or hard copy methods.

A unique aspect of the invention is its ability to accumulate personal data obtained from a variety of different electronic forms from a variety of different organizations, coherently sort and organize the data in its database (204), and then intelligently draw upon this accumulated data to then automatically fill out (i.e. pre-populate) other electronic forms with data. In this respect, it differs significantly from prior art such as the Common Application, Tax software, and the like which generally only accumulate personal data using a single form from a single organization, even though they may then distribute this data across multiple organizations.

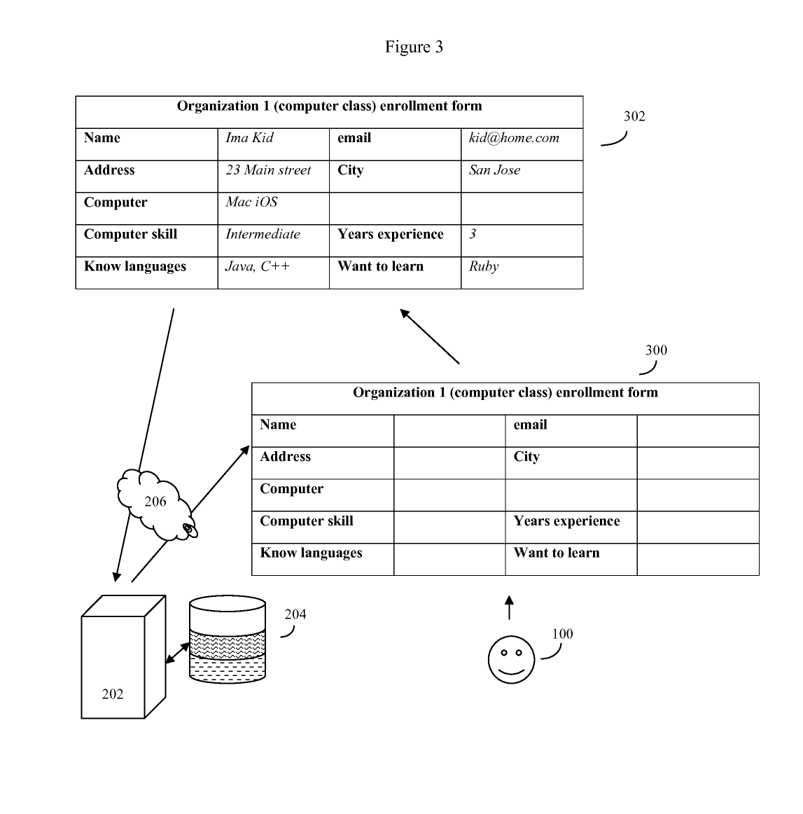

Because this data accumulation feature is such an important part of the invention, this aspect will be discussed in more detail in FIGS. 3-7.

FIG. 3 shows an example of the invention operating for a given user (100) for the first time, here using an editable blank (i.e. the form fields are not filled out) electronic form (120) for organization 1 (110). The blank version of form (120) is shown as (300).

Since this is the first time this user is using the system, the invention may have little or no information pertaining to either the primary user (100) or his secondary users (102, 104) in its database (204). Thus initially the server (202), either directly or indirectly, provides an electronic form (120) is essentially blank (i.e. not-pre-populated form) (300). That is, the various fields on this form (e.g. name, address, email etc.) are not filled in.

Here primary user (parent) (100) uses his or her ID code identify himself and his secondary systems to the user, as well as to access the form and data. The primary user fills out the electronic form, usually using his computerized client device (e.g. filling in a form in a web browser screen, filling in a fillable PDF form, and the like). The fully filled out version of form (120) (now form 121) is shown as (302). The user then either directly or indirectly (e.g. possibly via organization 1) submits the now filled out form (121) (302) back to the server (202). The server parses the form (see FIG. 7 for a specific example), extracts and stores the child's personal data in a database for anticipated later reuse, and also sends the now filled out form (121) (302) back to the first organization (not shown).

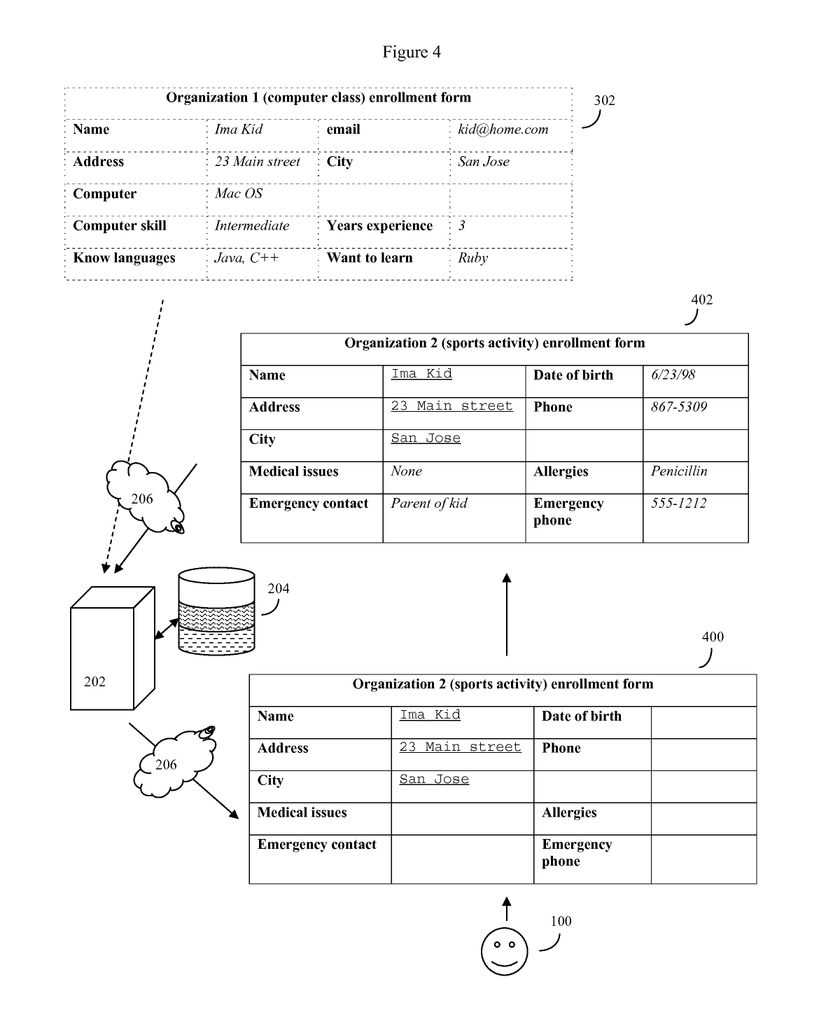

Once the invention's database starts to be filled up with data pertaining to a given primary user and the primary user's various secondary users, the invention can then act to facilitate filling in subsequent forms. This subsequent step is shown in FIG. 4.

FIG. 4 shows an example of the invention operating at a later time, this time using an editable electronic form (122) for organization 2 (112). Since this is the later time, the invention can now take advantage of personal data on the child (104), obtained from the previous filled in form (121), (302), to now pre-populate as much of organization 2's editable electronic form (122), (400) as it can, given available data. The pre-populated version of form (122) is shown as form (400), while the fully filled out version of form (122), also called (123) is shown as (402). This process is shown in more detail in FIG. 6.

As a result, the initial organization 2 form (400) that the user gets from the system is now already at least partially pre-populated with some personal data. Thus even after light use, the system already is starting to reduce the amount of work required to fill in form (400) because some of the data is already there.

The parent (100) then edits the organization 2 form (400) to supply the missing data (402), and again transmits it back to the server (202) either directly or indirectly. The server (202) again parses filled in the organization 2 form (402), again extracts and stores the child's personal data in the database (204) for possible later reuse, and also sends the completed form (402) (123) back to organization 2 (112) either directly or indirectly.

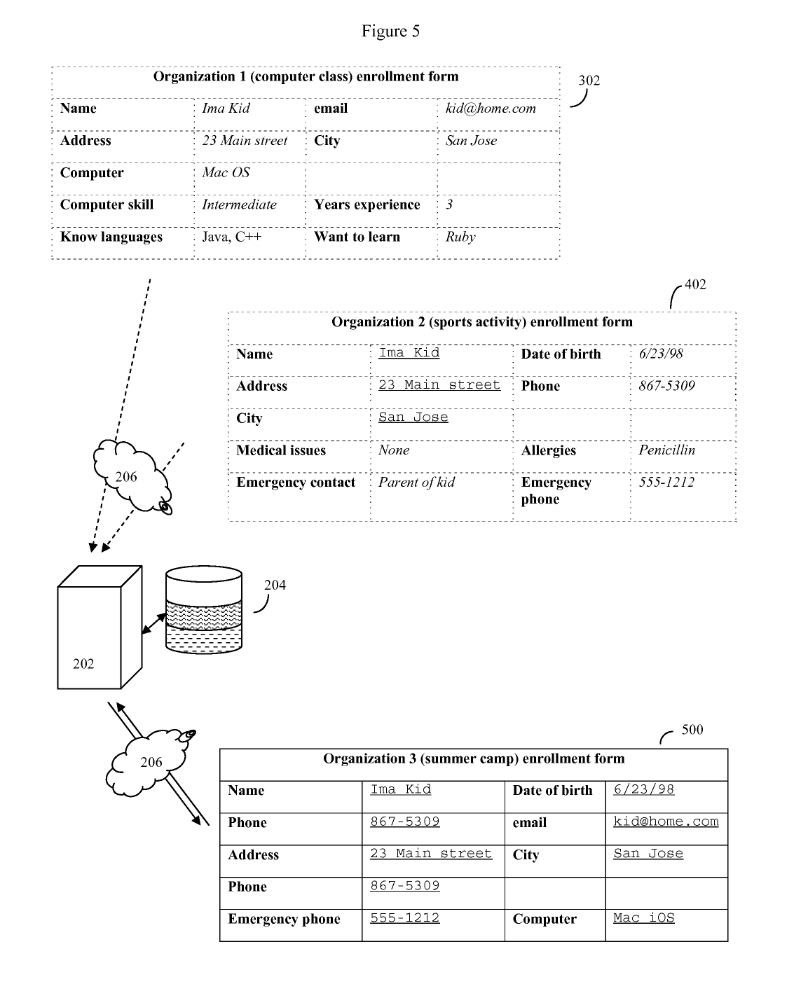

With more extended use, the invention would be able to almost completely pre-populate most forms because its database (204) now has accumulated a significant amount of data on the primary user (100) and secondary users (102, 104). An example of how the system operates after more extended use is shown in FIG. 5.

FIG. 5 shows an example of the invention operating at an even later time, here using an editable electronic form (126) for organization 3 (114). Since this an even later time, the invention's database (204) now has quite a large amount of personal data on the child (secondary user) (104) available, and can pre-populate almost all of organization 3's editable electronic form (126). This pre-populated version of form (126) is shown as (500).

As a result, the invention's server (202) is able to draw upon data in database (204) to almost entirely pre-populate form (126), and send this almost fully pre-populated form (500) to the parent (primary user) (100). Little work is now required. The parent now merely needs to check the pre-populated organization 3 form (500) for accuracy, make any corrections or tweaks as needed (generating form 127), and transmit it back to server (202) (not shown). The server checks the form for any changes, parses and again extracts and stores the child's personal data (or changes in the child's personal data) in the database (204) for possible later reuse, and also sends the form back to the third organization (114) either directly or indirectly.

To get a better idea of how server (202) and database (204) can both store blank forms (120, 122, 126) from various organizations, as well as parse the filled out versions of these forms (121, 123, 125, 127) for personal data, store this data in the database (204), and then draw upon the data from the database to fill out new blank forms, consider FIGS. 6 and 7.

FIG. 6 shows an example showing how the invention's server (202) and database may operate to flow or transfer personal data from the database (204) and database list (600) into various blank forms (122), thus producing the partially pre-populated organization 2 electronic form (400) previously shown in FIG. 4.

To do this, for each primary and/or secondary user, the invention's database (204) may create a list (600) of various possible electronic form fields and available data for these electronic form fields. Mapping data that maps items on this list to the various specific form fields may also be provided (not shown).

Database list (600) may also have many other different types of fields or data types beyond just standard user contact information. These fields or data types can also be fields for data pertaining to personal names, personal relationships, addresses, travel history, travel plans, insurance coverage, education, employment, banking information, immigration information, online accounts, service requests and essentially anything else as well.

The invention will usually also keep a database of non pre-populated electronic forms (120, 122, 126) for the various organizations (110, 112, 114) available, or at least have easy access to such forms if stored elsewhere.

Consider the scenario previously shown in FIG. 4. There the parent (100) had requested a pre-populated form for organization 2 (112). As shown in FIG. 6, to satisfy this request, the server (202) software took the “blank” organization 2 electronic form (122), and pre-populated as much of the form as it could with available data from the list (600). Thus, for example, the name and address was available, but the date of birth and phone numbers were not available. The invention then transmitted the partially pre-populated organization 2 form (400) to the parent.

List (600), although not fully populated (i.e. some fields are still blank) does contain the sorted primary user entered personal data that was previously entered into the system in FIG. 3. Because this list is only partially populated with data, the invention was only able to partially pre-populate form (400). To do still better, the system will need to obtain more user personal data.

To get this additional user personal data, the invention's server and database will generally also be configured to scan, read, parse or otherwise extract personal data that the user(s) have entered into various forms. The invention will then take this data, and either populate the database (204) and in particular the database lists (600) with this personal data, or at least update various fields in database (204) and lists (600) with more recent personal data (i.e. perhaps a new user address).

This process of reading user data from various forms, and using this user data to then populate or update various data fields in database (204) and database list (600) is shown in FIG. 7.

FIG. 7, shows how the system may read personal data and store it for later use. In this example, assume that the parent (100) from FIG. 5 has just filled in the missing data (i.e. blank regions) in form (400), thus creating filled-in form (402), and has just transmitted (700) this filled in form (also designated as (123) back to the server (202). Note that this parent filled-in form (402) contains information in many data fields, such as date of birth, phone number, emergency contact, etc. that was not previously in database list (600) shown in FIG. 6.

At the server, the server parses form (402), and uses the additional data from form (402) to supplement or further fill out the various data fields or items in list (600) in database (204). This data supplemented list is now designated as (702), and the new data just obtained from form (402) is shown underlined. Thus this latest form has provided the missing date of birth information, phone number information, emergency contact information, and the like.

As a result, then at a later time, if the parent (100) then requests that the system provide him with a pre-populated version of blank form (126) in order to allow his or her child to enroll in organization 3 (114), the now more populated database list (702) has enough information to fully pre-populate the blank form (126) with data (here using the method previously shown in FIG. 6, but now with more data available). All the parent would have to then do is simply glance at the form, verify that the data was still correct, and then send the now automatically populated form (127) to organization (114) (either directly or indirectly, and often via server 202), thus saving a substantial amount of time and effort.

As previously discussed, in the event that the more recent personal data from a more recent form conflicts or is otherwise inconsistent with earlier data, then the system can optionally also automatically update the earlier submitted electronic forms with the more recent user data. Thus for example, if the user gets a new address or phone number, and indicates this in a form for organization (114), the invention can also (usually according to user or organization preference) automatically send this updated address and telephone number to other organizations that the user has previously enrolled in, such as organization (110) and (112).

In some cases, inconsistent data should not be updated, but merely retained on the system as multiple options. For example, a child could potentially have two different addresses at the same time. In this case, the invention and server can also be configured to cope with multiple possible options, for example by storing user preferences, providing pull-down lists, and the like.

### Additional Methods

Returning to FIG. 2, the primary user (100) (or secondary users as well) can authorize the various organizations (110, 112, 114) to use various methods to retrieve the filled out organizational forms (121, 123, 125, 127) or other user data.

In one preferred embodiment, the user(s) may send identification number (200) to a particular organization (usually also along with authorization for the organization to obtain the relevant data). Although any communication method may be used, in a preferred embodiment, trusted electronic communication methods will often be used. Such trusted electronic communication methods can include trusted internet communications (e.g. using https or other secure or encrypted method), telephone messages from trusted telephone numbers to trusted telephone attendants, email from trusted primary user email addresses to trusted email addresses, and SMS messages from trusted cellular phones to trusted telephone numbers. Additionally other trusted methods, such as Radio Frequency Identification (RFID) tags and trusted RFID readers, trusted QR codes and trusted QR code reading devices, and trusted Near Field Communication devices and trusted NFC readers may be used.

Use with Third Parties

In some cases, such as when a child needs clearance from the child's physician for vaccination status, health status, and the like, third parties, typically trusted third parties, will also need access to the various forms. These third parties will usually need to add data that should not then be subsequently edited by the primary user (100), and/or make trusted third party endorsements of this data such as providing authorized third party signatures.

To do this, in some embodiments, the invention may also provide editable electronic forms with various form fields or data types that are reserved for editing by trusted third parties. The invention may then, usually upon direction by user (100), or optionally upon direction by the organization (e.g. 110, 112, 114) itself then transmit these “trusted third party” editable forms to one or more trusted third parties. The invention will then allow these trusted third parties to edit their respective fields, as well as optionally add digital signatures and/or uses other authentication methods to verify the third parties identity and/or to verify that the third party transaction is a secure transaction.

The third party edited forms may then either be sent back directly or indirectly to the relevant organization. Often the invention may be configured to allow the primary user (100) (and optionally the secondary users as well) to retrieve this “trusted third party” editable form, and optionally review and approve or disapprove the third party comments, and/or send the form back to the third party for further editing. Often however, to preserve the integrity of the third party data, the primary user (100) will not be allowed to directly edit these third party fields.

1. A method to automatically pre-populate editable electronic forms with previously entered user data, said method comprising:
assigning identification numbers to a plurality of users, at least some of said users being primary users who are in a position of trust with respect to secondary users, said identification numbers further identifying the trust relationship between said primary users and secondary users;
using a plurality of user editable electronic forms for a plurality of different organizations to collect primary user entered personal data regarding either said primary users or said secondary users;
storing said primary user entered personal data and identification numbers in at least one computer database, and further sorting said primary user entered personal data according to data type;
wherein, when said primary users desire to interact with one or more previously used or new editable electronic forms pertaining to either said primary users or said secondary users, using the sorted primary user entered personal data and identification numbers to pre-populate at least some of the fields in said previously used or new editable electronic forms with the sorted primary user entered personal data; and
presenting said pre-populated previously used or new editable electronic forms to said primary users for subsequent primary user editing and/or verification.

2. The method of claim 1, wherein said primary users who are in a position of trust with respect to secondary users comprise parents and children, children and parents, spouses, and other individuals with a legal trust relationship.

3. The method of claim 1, wherein said identification numbers comprise information pertaining to said primary user's country of origin, residence, or citizenship, said primary user's original date of registration, a random number, and information uniquely liking said primary user to one or more secondary users.

4. The method of claim 1, wherein said editable electronic forms are web based electronic forms, and said web based electronic forms are viewed and edited using a web browser or app in an internet network connected computerized device.

5. The method of claim 1, wherein if said primary user enters data of a given data type on a later submitted electronic form that is inconsistent with data of the same data type on one or more earlier submitted electronic forms, then automatically updating the one or more earlier submitted electronic forms with the later submitted data of the same data type.

6. The method of claim 1, wherein a primary user may authorize an organization to retrieve at least some data pertaining to said primary user or a secondary user by sending said identification number to said organization using trusted electronic communication methods, said trusted electronic communication methods comprising trusted internet communications, telephone messages from trusted telephone numbers to trusted telephone attendants, email from trusted primary user email addresses to trusted email addresses, SMS messages from trusted cellular phones to trusted telephone numbers, trusted Radio Frequency Identification (RFID) tags and trusted RFID readers, trusted QR codes and trusted QR code reading devices, and trusted Near Field Communication devices and trusted NFC readers.

7. The method of claim 1, wherein said user editable electronic forms are further designed to visually resemble the organization's standard paper forms, standard Portable Document Format (PDF) forms, or other standard forms.

8. The method of claim 1, wherein said organizations comprise at least one organization selected from the group consisting of business organizations, educational organizations, government departments, and private clubs.

9. The method of claim 1, wherein said data types comprise at least one data type selected from the group consisting of personal names, personal relationships, addresses, travel history, travel plans, insurance coverage, education, employment, banking information, immigration information, online accounts, and service requests.

10. The method of claim 1, wherein at least some of said editable electronic forms further comprise fields reserved for editing by trusted third parties;
wherein if said editable electronic form is also a third party editable electronic form containing at least one third party editable field reserved for editing by one or more trusted third parties, further transmitting said third party editable electronic form to said one or more trusted third parties, allowing said one or more trusted third parties to edit said at least one third party editable field;
wherein said primary user subsequently retrieve said third party editable electronic form and review approve or disapprove said third party editable fields, but not edit said third party editable fields.

11. A computer network implemented method to automatically pre-populate editable electronic forms with previously entered user data, said method comprising:
using at least one server to automatically assign identification numbers to a plurality of users, at least some of said users being primary users who are in a position of trust with respect to secondary users, said identification numbers further identifying the trust relationship between said primary users and secondary users;
wherein said primary users who are in a position of trust with respect to secondary users comprise parents and children, children and parents, spouses, and other individuals with a legal trust relationship;
wherein said identification numbers comprise information pertaining to said primary user's country of origin, residence, or citizenship, said primary user's original date of registration, a random number, and information uniquely liking said primary user to one or more secondary users;
transmitting at least one user editable form selected from a plurality of user editable electronic forms for a plurality of different organizations to a remote client computerized device, and using said remote client computerized device to collect primary user entered personal data regarding either said primary users or said secondary users;
transmitting said primary user entered personal data at least one server using a network connection, storing said primary user entered personal data and identification numbers in at least one computer database accessible by at least one server, and further sorting said primary user entered personal data according to data type;
wherein, when said primary users desire to interact with one or more previously used or new editable electronic forms pertaining to either said primary users or said secondary users, said at least one server uses the sorted primary user entered personal data and identification numbers to pre-populate at least some of the fields in said previously used or new editable electronic forms with the sorted primary user entered personal data and transmit these pre-populated forms to a remote client computerized device; and
using said remote client computerized device to presenting said pre-populated previously used or new editable electronic forms to said primary users for subsequent primary user editing and/or verification, and transmitting said subsequent primary user editing data and or verification data back to said at least one server;
and further transmitting said pre-populated data and/or said subsequent primary user editing data and/or verification data to the organization associated with said at least one user editable form.

12. The method of claim 11, wherein said editable electronic forms are web based electronic forms, and said web based electronic forms are viewed and edited using a web browser or app in said remote client computerized device.

13. The method of claim 11, wherein if said primary user enters data of a given data type on a later submitted electronic form that is inconsistent with data of the same data type on one or more earlier submitted electronic forms, then automatically updating the one or more earlier submitted electronic forms with the later submitted data of the same data type.

14. The method of claim 11, wherein a primary user may authorize an organization to retrieve at least some data pertaining to said primary user or a secondary user by sending said identification number to said organization using trusted electronic communication methods, said trusted electronic communication methods comprising trusted internet communications, telephone messages from trusted telephone numbers to trusted telephone attendants, email from trusted primary user email addresses to trusted email addresses, SMS messages from trusted cellular phones to trusted telephone numbers, trusted Radio Frequency Identification (RFID) tags and trusted RFID readers, trusted QR codes and trusted QR code reading devices, and trusted Near Field Communication devices and trusted NFC readers.

15. The method of claim 11, wherein said user editable electronic forms are further designed to visually resemble the organization's standard paper forms, standard Portable Document Format (PDF) forms, or other standard forms.

16. The method of claim 11, wherein said organizations comprise at least one organization selected from the group consisting of business organizations, educational organizations, government departments, and private clubs.

17. The method of claim 11, wherein said data types comprise at least one data type selected from the group consisting of personal names, personal relationships, addresses, travel history, travel plans, insurance coverage, education, employment, banking information, immigration information, online accounts, and service requests.

18. The method of claim 11, wherein at least some of said editable electronic forms further comprise fields reserved for editing by trusted third parties;
wherein if said editable electronic form is also a third party editable electronic form containing at least one third party editable field reserved for editing by one or more trusted third parties, further transmitting said third party editable electronic form to said one or more trusted third parties, allowing said one or more trusted third parties to edit said at least one third party editable field;
wherein said primary user can subsequently retrieve said third party editable electronic form and review approve or disapprove said third party editable fields, but not edit said third party editable fields.
